(19) United States
(12) Patent Application Publication
(10) Pub. No.: US 2003/0226464 A1
(43) Pub. Date: Dec. 11, 2003

(54) Method to keep copies of device queued jobs in the network queue until print delivery is guaranteed

(75) Inventor: Rono James Mathieson, Camas, WA (US)

Correspondence Address: Robert D. Varitz, ROBERT D. VARITZ, P.C., 2007 S.E. Grant Street, Portland, OR, 97214, US

(73) Assignee: Sharp Laboratories of America, Inc.

(21) Appl. No.: 10/166,484

(22) Filed: Jun. 10, 2002

(51) Int. Cl. B41F 1/54; B41L 5/12

(52) U.S. Cl. 101/484

(57) ABSTRACT

A method of handling print jobs between a network server over a communications network to a print output device, wherein the network server includes a network print queue and wherein the print output device may includes a rasterizer and an internal print queue; and which includes allowing the network server to transmit print jobs to a print output device while other print jobs are pending in the print output device; and providing the print output device with an acknowledgement mechanism, which acknowledges completion of a print job to the network server only after a print job has been physically printed.

### FIELD OF THE INVENTION

This invention relates to managing jobs, i.e., print or copy jobs, that are stored in the internal queue of an MFP or other print output device, e.g., copier, printer, scanner or fax. Specifically, managing those jobs in devices that do not have sufficient non-volatile memory to retain the job in the event of the device being shut off.

### BACKGROUND OF THE INVENTION

In today's digital printers and MFP's, there is the ability to queue one or more print jobs in the device. They may also have the ability to queue print, copy, scan or fax jobs. In devices that use volatile memory such as DRAM to store the jobs, once these jobs are queued on the device they may be lost in the event of the device being shut off or a power failure.

Another prior art problem involves PIN (personal identification number) encoded print jobs, which provide security for sensitive information. PIN print jobs will not be physically printed until a users enters a PIN on the print output device. PIN print jobs typically are processes, including rasterization, if necessary, and remain in the print output device internal print queue, thus occupying space in the queue, producing queue congestion. This results in (1) the internal print queue may be filled, preventing other print jobs from being processed; and (2) the processed PIN print job will be lost in the event of a power failure of the print output device.

In the prior art, this problem has been solved by placing nonvolatile memory such as a hard disk in the device.

U.S. Pat. No. 6,33,789 B1, to Shima, for Printing system, method and apparatus for processing a plurality of types of information different in priority, granted Dec. 25, 2001, describes a system incorporating a number of logical channels between a printer and a computer over a network or LAN. A plurality of buffers for the different types of information are provided.

U.S. Pat. No. 6,275,299 B1, to Beck, for Multiple spooler printing system, granted Aug. 14, 2001, describes the use of a dedicated spooler for each printer associated with a network.

U.S. Pat. No. 6,184,996 B1, to Gase, for Network printer with remote print queue control procedure, granted Feb. 6, 2001, describes use of the Internet to send data to a printer for output, and the provision of print status information to a user at a remote site.

U.S. Pat. No. 5,995,723, to Sperry et al., for Client subsystem for changing document/job attributes in a network printing system, describes a method for changing print job attributes dependent on the spooler/printer which receives the print job.

U.S. Pat. No. 5,982,996, to Snyders, for Mechanism for printer driver switching in Windows operating system to allow distribution of print jobs to an output device from a single print request within an application, granted Nov. 9, 1999, describes a method for changing print job attributes dependent on the printer which receives the print job, and upon the driver located in the output device.

U.S. Pat. No. 5,970,223, to Debes et al., for Job interrupt system for multifunctional printing system, granted Oct. 19, 1999, describes a method for stopping output of a print job, and beginning printing of a job having a higher print priority.

U.S. Pat. No. 5,873,659, to Edwards et al., for Method and apparatus for providing a printer having internal queue job management, granted Feb. 23, 1999, describes a printer having a sizable memory therein, which may be used to hold and print print jobs according to priority, and which may retain a ‘deleted’ print job, allowing for the reinstatement of the print job.

U.S. Pat. No. 5,859,711, to Barry et al., for Multiple print engine with virtual job routing, granted Jan. 12, 1999, describes use of a distribution processor to spool the print jobs to a print engine.

U.S. Pat. No. 5,592,683, to Chen et al., for System for selectively processing nested print commands and buffered post-print commands thereafter and resending selected portions of data stream upon error detection, granted Jan. 7, 1997, describes a system having a buffer for holding print commands while a job is printing.

U.S. Pat. No. 5,528,375, to Wegeng et al., for Apparatus for and method of scheduling and printing a job in a printing machine, granted Jan. 18, 1996, describes use of a memory device in a printer to store print jobs in the form of image data, and building a scheduling list to prioritize the print jobs.

### SUMMARY OF THE INVENTION

A method of handling print jobs between a network server over a communications network to a print output device, wherein the network server includes a network print queue and wherein the print output device may include a rasterizer and an internal print queue; and which includes allowing the network server to transmit print jobs to a print output device while other print jobs are pending in the print output device; and providing the print output device with an acknowledgement mechanism, which acknowledges completion of a print job to the network server only after a print job has been physically printed.

It is an object of the invention to provide a method to preserve queued jobs in the event of power failure or in the event that a print output device is switched off.

Another object of the invention is to provide storage for PIN print jobs in a non-congestive manner until a PIN is entered on the print output device by the user.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts a prior art method of queuing print jobs.

FIG. 2 depicts a protocol for queuing print jobs according to the method of the invention.

### DETAILED DESCRIPTION OF THE PREFERRED EMBODIMENTS

In the method of the invention, the problem of lost, queued print jobs, is solved by maintaining the print job in a network queue until physical delivery of the print job by the print output device is assured. In addition, this is done in a manner that still allows the benefits of ripping (raster image processing), if necessary, ahead and storing the jobs in the device queue. Further, personal identification number (PIN) encoded print jobs may be handled in a non-congestive manner.

This invention provides a means to maintain these jobs both on the device and in a network queue so that the print jobs will not be lost. This is accomplished by changing the communications between the device and the network queue so that the network queue will not be cleared upon the job being fully received, processed and stored in the device queue. The method of the invention is accomplished primarily through software which is used to control an print output device, although the method could be embodied in dedicated hardware, such as an ASIC.

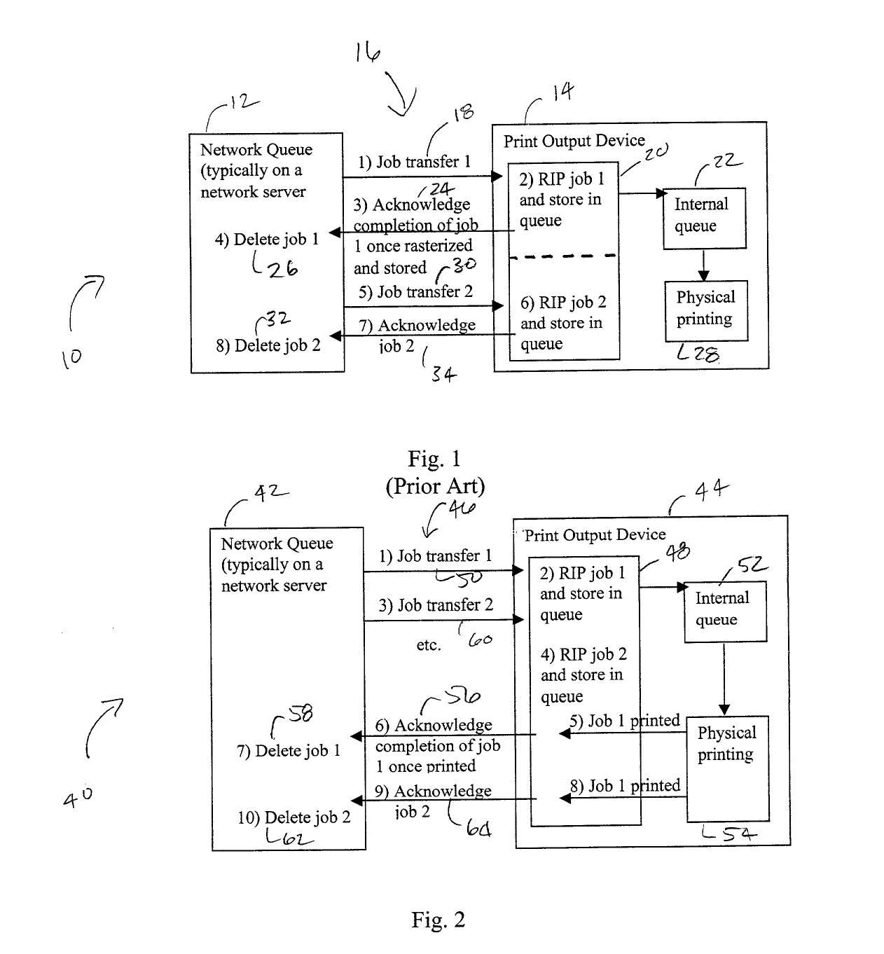

This invention changes the communications between a print output device and the network queue that provides the print job to the print output device. The normal protocol that is followed is depicted in FIG. 1, generally at 10. Process 10 includes a system having a network server 12, and output device 14, and a connection therebetween in the form of a communications network 16. A first print job 18 is transferred from server 12 to print output device 14. As first print job 18 is received in device 14, it is rasterized by a rasterization processor (RIP) 20, if necessary, and stored in an internal device queue 22. In the case of a ready-to-print file, such as a *.tif file, rasterization is not required. Once the print job is ready to print, device 14 acknowledges 24 completion of the job to the network queue in server 12, and the network queue deletes 26 the job from its memory. This is typically done before the job has been physically printed by a print engine 28 in print output device 14. This protocol is followed because RIP 20 needs to acknowledge the completion of the first print job before it can begin receiving a second, or next, print job 26. Second print job 30 will be deleted 32 from server 12 queue once it has been rasterized and an acknowledgement 34 is sent to server 12.

Hence, acknowledgement of rasterization, or processing, of a print job results in deletion of the print job from the network queue, which provides for efficient processing of print jobs over a communications network. However, in the event of a power failure, or other print output device malfunction while a print job is in internal queue 22, the print job will be lost. Prior art methods solve this problem by providing a memory device in output printer device 14, such as a hard drive, and its associated circuitry and software. This is a relatively costly solution, and increases the complexity of the print output device.

In the method of the invention, the communications are changed as shown in FIG. 2, generally at 40. This change in communications is accomplished by providing software components for a network server 42, having a network printer queue therein, which enables the transfer of multiple jobs to an print output device 44 over a network 46, which transfer is not dependent on completion, i.e., rasterization by a rasterization processor 48, if necessary, of any print jobs already sent to the print output device, and wherein a print job in the network server is retained until an acknowledgement is received indicating that the print job has been physically printed. A further change to the software in the print output device provides for generation of an acknowledgement by the print output device, which is sent to the network server. As used herein, “print engine” includes the paper handling mechanism of the print output device, and the image fixing mechanism. As used herein, “processing” includes rasterizing, or ripping, of a non-ready-to-print print job and whatever is necessary to physically print a print job which is ready-to-print, such as in the case of a *.tif file.

In the method of this invention, a first print job 50 is transferred to print output device 44 and processed by raster image processor 48, the processed print job being stored in a print output device internal queue 52. Once first print job 50 is stored in internal queue 52, a second print job 60, and subsequent print jobs, can be transferred to print output device 44, and is processed in the same fashion. Once first print job 50 is physically printed by a print engine 54, an acknowledgment 56 is sent from print engine 54 to processor 48, and then to network server 42, which only then is allowed to delete the first print job. Second print job 60 and subsequent jobs will be acknowledged in the same fashion. In the event that a print job is in a ready-to-print format, the print job will by-pass processor 48. This only requires that the job completion acknowledgment logic between the print output device and the network queue be modified so that acknowledgments are only given after the job is physically printed and so that the network queue will release subsequent jobs prior to receiving acknowledgement of the completion of the prior jobs. Thus, the acknowledgement mechanism between the print output device and the network queue is modified in the method of the invention, differentiating the method of the invention from the prior art. The method of the invention also allows a print output device constructed according to the method of the invention to receive a subsequent print job from the network prior to completion of processing and printing of the first print job.

In this invention, multiple jobs are transferred to the print output device, processed and transferred to the internal device queue for printing. Acknowledgment of the completion of these print jobs is returned to the network queue in an asynchronous fashion when the physical printing of the job is completed. This allows the print output device to efficiently process the print jobs while maintaining copies of the data on the network queue. In this way, if the device is powered off for any reason prior to the physical printing of the jobs, the jobs will be resubmitted from the network queue when power is restored to the device. Power fail job retention can be provided without the expense of nonvolatile memory, such as a hard drive.

In the case of PIN print jobs, congestion may occur in the internal queue, as PIN print jobs will not physically print until a users enters the proper PIN. In the event of a power failure, any processed print jobs in the internal queue will be lost, and the presence of PIN print jobs in the internal queue may prevent the receipt of additional non-PIN print jobs by the print output device. One approach of the method of the invention for PIN print jobs is to merely strip off header information from the print file, and store the header information in the internal queue, holding the remainder of the print job on the network server until the PIN is entered. Another approach of the method of the invention is to process the PIN print job, including rasterization if necessary, and store the processed PIN print job on the network server until the users enters the proper PIN.

Other embodiments may function in environments without a network queue, such as network peer-to-peer printing for direct connect printing environments.

Thus, a method to keep copies of device queued jobs in the network queue until print delivery is guaranteed has been disclosed. It will be appreciated that further variations and modifications thereof may be made within the scope of the invention as defined in the appended claims.

I claim:

1. A method of handling print jobs between a network server over a communications network to a print output device, wherein the network server includes a network print queue and wherein the print output device includes an internal print queue; comprising:
allowing the network server to transmit print jobs to a print output device while other print jobs are pending in the print output device; and
providing the print output device with an acknowledgement mechanism, which acknowledges completion of a print job to the network server only after a print job has been physically printed.

2. The method of claim 1 which includes transmitting a first print job to the print output device and processing the first print job, including:
processing the first print job to produce a processed first print job;
storing the processed first print job in the internal print queue;
physically printing the processed first print job;
generating an acknowledgement message in the print output device;
transmitting the acknowledgement message to the processor and transmitting the acknowledgement message to the network server;
deleting the first print job; and
transmitting a second print job to the print output device during said processing and said physically printing of the first print job.

3. The method of claim 1 which includes providing an acknowledgment mechanism in the print output device for generating the acknowledgement message.

4. The method of claim 1 wherein the print job is a PIN encoded print job, and wherein said processing includes stripping a header portion of the PIN print job, storing the stripped header portion in the print output device internal queue, and storing a remainder of the PIN print job in the network print queue until the PIN is entered on the print output device.

5. The method of claim 1 wherein the print job is a PIN encoded print job, and wherein said processing includes processing the PIN encoded print job to make a processed ready-to-print file, and storing the ready-to-print file in the network print queue until the PIN is entered on the print output device.

6. A method of handling print jobs between a network server over a communications network to a print output device comprising:
transmitting a first print job from the network server to the print output device and processing the first print job to form a processed first print job, including:
storing the processed first print job in the internal print queue;
physically printing the processed first print job in the print output device;
generating an acknowledgement message of the print output device;
transmitting the acknowledgement message to the network server;
deleting the first print job; and transmitting a second print job to the print output device during said processing of the first print job.

7. The method of claim 6 which includes allowing the network server to transmit print jobs to the print output device while other print jobs are pending in the print output device; and providing the print output device with an acknowledgement mechanism, which generates an acknowledges message only upon completion of physical printing of a print job.

8. The method of claim 6 wherein said processing includes raster image processing to rasterize the first print job to produce a rasterized first print job; and wherein said transmitting includes transmitting the acknowledgement message to the raster image processor.

9. The method of claim 6 wherein the print job is a PIN encoded print job, and wherein said processing includes stripping a header portion of the PIN print job, storing the stripped header portion in the print output device internal queue, and storing a remainder of the PIN print job in the network print queue until the PIN is entered on the print output device.

10. The method of claim 6 wherein the print job is a PIN encoded print job, and wherein said processing includes processing the PIN encoded print job to make a processed ready- to-print file, and storing the ready-to-print file in the network print queue until the PIN is entered on the print output device.

11. A method of handling print jobs between a network server over a communications network to a print output device, wherein the network server includes a network print queue and wherein the print output device includes a processor for readying print jobs for physical printing;
and an internal print queue; comprising:
allowing the network server to transmit print jobs to a print output device while other print jobs are pending in the print output device;
transmitting a first print job to the print output device and processing the first print job, including:
processing the first print job to produce a processed first print job;
storing the processed first print job in the internal print queue;
physically printing the processed first print job;
providing the print output device with an acknowledgement mechanism, which generate an acknowledgement message for acknowledging completion of a print job to the network server only after a print job has been physically printed by the print output device;
generating the acknowledgement message;
transmitting the acknowledgement message to the processor and transmitting the acknowledgement message to the network server;
deleting the first print job; and
transmitting a second print job to the print output device during said processing of the first print job.

12. The method of claim 11 wherein the print job is a PIN encoded print job, and wherein said processing includes stripping a header portion of the PIN print job, storing the stripped header portion in the print output device internal queue, and storing a remainder of the PIN print job in the network print queue until the PIN is entered on the print output device.

13. The method of claim 11 wherein the print job is a PIN encoded print job, and wherein said processing includes processing the PIN encoded print job to make a processed ready-to-print file, and storing the ready-to-print file in the network print queue until the PIN is entered on the print output device.
